(19) United States
(12) Patent Application Publication
(10) Pub. No.: US 2026/0235100 A1
(43) Pub. Date: Aug. 13, 2026

(54) WATER-BASED RENEWABLE ELECTRICITY GENERATION SYSTEM

(71) Applicant: Matthew Shun, Glendale, CA (US)

(72) Inventor: Matthew Shun, Glendale, CA (US)

(21) Appl. No.: 19/636,145

(22) Filed: Apr. 1, 2026

Related U.S. Application Data
(63) Continuation-in-part of application No. 18/958,066, filed on Nov. 25, 2024, now abandoned.
(60) Provisional application No. 63/696,526, filed on Sep. 19, 2024.

(51) Int. Cl. F03B 13/10; F03B 11/00; H02J 3/38; H02J 101/20

(52) U.S. Cl. CPC F03B 13/10; F03B 11/002; F03B 11/004; F03B 11/006; H02J 3/381; H02J 2101/20

(57) ABSTRACT

An ocean electricity generation system designed to harness the kinetic energy of ocean water to produce renewable electricity. The system includes a submerged steel tube container with a plurality of watertight compartments. A bottom compartment houses an impeller connected to a vertically aligned shaft which drives a generator located in the top compartment. Air compressors in the middle compartment fill air flasks with compressed air which is used to expel water from the impeller chamber, causing the impeller to rotate and generate electricity. The system further features an air supply pipe, valves for controlling water and air flow, and a transmission cable for delivering electricity to an external grid. An artificial intelligence (AI) module optimizes system performance based on ocean conditions and energy demand. One or more sensors enable remote monitoring and predictive maintenance.

### CROSS-REFERENCE TO RELATED APPLICATION

The present application is a continuation-in-part patent application of U.S. Patent Application No. 18/958,066, which was filed on November 25, 2024 and claims priority to, and the benefit of, U.S. Provisional Application No. 63/696,526, which was filed on September 19, 2024, both of which are incorporated herein by reference in their entirety.

### FIELD OF THE INVENTION

The present invention generally relates to ocean-based renewable energy systems. More specifically, the invention relates to an ocean electricity generation system designed to harness the kinetic energy of water to produce clean and renewable electricity. The system comprises a submerged steel tube container with multiple compartments, including an impeller in the bottom compartment connected to a generator via a vertical shaft. A water pipe with a valve will let water down to the bottom compartment to spin the impeller and generate electricity. Air compressors in a middle compartment fill air flasks with compressed air, which is used to expel water from the impeller chamber, causing the impeller to rotate and generate electricity. Accordingly, this disclosure makes specific reference thereto the present invention. Nonetheless, it is to be appreciated that aspects of the present invention are also equally applicable to other like applications, devices, and methods of manufacture.

### BACKGROUND

By way of background, fossil fuels, such as coal, oil, and natural gas, have been the primary sources of energy for decades. However, they are a non-renewable resource and will eventually be depleted. The combustion of fossil fuels releases large amounts of greenhouse gases, primarily carbon dioxide (CO₂) and methane (CH₄), into the atmosphere. Greenhouse gases contribute to global warming and climate change by trapping heat in the Earth's atmosphere, resulting in rising global temperatures. The increase in temperature leads to environmental challenges such as melting polar ice, rising sea levels, and more frequent extreme weather events, such as hurricanes and droughts. Additionally, the processes involved in extracting and using fossil fuels, such as oil spills, mining operations, and coal ash disposal, cause widespread contamination of water sources. This pollution negatively impacts marine life and ocean ecosystems, disrupting biodiversity and threatening species that depend on clean water.

The health risks associated with fossil fuel combustion are significant. Air pollution from burning fossil fuels is linked to a range of respiratory issues, including asthma, chronic obstructive pulmonary disease (COPD), and lung cancer. Workers in fossil fuel extraction industries, such as mining, drilling, and refining, face hazardous conditions. There is an urgent need for renewable energy systems that are sustainable, eco-friendly, and capable of reducing our dependence on fossil fuels.

Therefore, there exists a long-felt need in the art for a renewable energy system that can harness the kinetic energy of ocean water to generate electricity in a reliable and sustainable manner. There is a long-felt need for a system that reduces dependency on fossil fuels while providing consistent and renewable power. Additionally, there is a long-felt need for a system that can use abundant water resources in coastal or island regions areas to create a stable energy supply. Moreover, there is a long-felt need for an ocean-based power generation system that operates continuously and efficiently, using a combination of water flow and air pressure to generate electricity. Further, there is a long-felt need for a system that minimizes environmental impact and provides an alternative to traditional power plants. Finally, there is a long-felt need for an ocean energy system that allows island and lakeside communities to generate renewable power in an effective manner.

The subject matter disclosed and claimed herein, in one embodiment, comprises an ocean electricity generation plant designed to harness the kinetic energy of ocean water for the production of electricity. The system includes a steel tube structure that is submerged beneath the surface of a water body and contains a plurality of watertight compartments. A generator is positioned in the top compartment and is connected to an impeller located in the bottom compartment via a vertical shaft. The impeller is driven by water flow and transfers the rotational energy to the generator to produce electricity. Additionally, the system includes air compressors and air flasks which pressurize the impeller chamber and expel water to drive the impeller's rotation. The system uses an air supply pipe to draw in air from above the water surface.

In this manner, the ocean electricity generation plant of the present invention accomplishes all of the foregoing objectives, providing a dynamic, renewable, and eco-friendly solution to electricity generation. The system offers a reliable alternative to fossil fuel power plants by using the natural flow of ocean water to generate clean electricity without harmful emissions. The system combines the forces of water flow and air pressure to create a continuous cycle of power generation. The system harnesses the natural movement of water and uses air pressure to generate electricity, offering a sustainable, renewable energy source. The system can be installed near coastal areas, islands, or other locations near large bodies of water.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an ocean electricity generation system. The system comprises a steel tube container submerged beneath the surface of a water body, an impeller is disposed in a bottom compartment of the steel tube container, the impeller has a plurality of blades adapted to rotate when water flows over the blades, a shaft is vertically disposed in the steel tube container, the shaft couples the impeller to an electric generator disposed in a top compartment of the steel tube container, wherein the rotation of the impeller is transferred to the generator via the shaft for generating electricity, an air supply pipe extends from a position above the water surface into a middle compartment of the steel tube container, the air supply pipe is adapted to draw air into the middle compartment, one or more air compressors are disposed in the middle compartment, the compressors are adapted to fill one or more air flasks with compressed air, and a valve is disposed on a water supply pipe adapted to control the inflow of water into the bottom compartment.

In another aspect, an ocean electricity generation system is disclosed. The system includes a steel tube container submerged beneath a water surface and has multiple compartments, including a bottom compartment containing an impeller connected to a vertically aligned shaft, the shaft is coupled to a generator located in a top compartment of the container. An air supply pipe extends from the water surface to a middle compartment, the middle compartment contains air compressors that fill air flasks with compressed air, a valve each is configured to regulate water inflow and air pressure, an artificial intelligence (AI) module is configured to monitor and optimize the operation of the system in real-time by adjusting air pressure and impeller rotation based on ocean current predictions and external energy demand, and one or more sensors are disposed in the system to detect operational parameters and transmit real-time data to a remote control unit for predictive maintenance and automatic shutdown during hazardous conditions.

In another embodiment, a method for generating electricity using an ocean electricity generation system is disclosed. The method includes the steps of allowing water to flow into a bottom compartment of a submerged steel tube structure, the bottom compartment contains an impeller, pressurizing the bottom compartment using compressed air stored in air flasks within the system, wherein the compressed air is supplied from air compressors that draw air from above the water surface through an air supply pipe, expelling the water from the bottom compartment using the compressed air, causing the impeller to rotate, transferring the rotational movement of the impeller to a generator through a vertically disposed shaft to generate electricity, and transmitting the generated electricity from the generator to an external power grid via a transmission cable.

In yet another aspect, the impeller comprises fish-friendly blades to minimize the impact on marine life by reducing blade sharpness and incorporating materials that absorb vibrations to decrease noise and disruption to nearby ecosystems.

In one embodiment, the system includes a self-healing polymer coating applied to the exterior of the steel tube structure, the coating being adapted to automatically repair minor damages caused by water pressure, marine debris, or corrosion.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters

refer to similar parts throughout the different views, and in which:

FIG. 1 illustrates a perspective view of the electricity generation ocean plant of the present invention in accordance with the disclosed structure;

FIG. 2 illustrates a schematic view showing remote monitoring of the electricity generation ocean plant of the present invention in accordance with the disclosed structure;

FIG. 3 illustrates a perspective view showing the electricity generation ocean plant of the present invention installed in a water body in accordance with the disclosed structure; and

FIG. 4 illustrates a flow chart depicting a process of generation of electricity using the system of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a renewable energy system that can harness the kinetic energy of ocean water to generate electricity in a reliable and sustainable manner. There is a long-felt need for a system that reduces dependency on fossil fuels while providing consistent and renewable power. Additionally, there is a long-felt need for a system that can use abundant water resources in coastal or island regions areas to create a stable energy supply. Moreover, there is a long-felt need for an ocean-based power generation system that operates continuously and efficiently, using a combination of water flow and air pressure to generate electricity. Further, there is a long-felt need for a system that minimizes environmental impact and provides an alternative to traditional power plants. Finally, there is a long-felt need for an ocean energy system that allows island and lakeside communities to generate renewable power in an effective manner.

The present invention, in one exemplary embodiment, is an ocean electricity generation system. The system includes a steel tube container submerged beneath a water surface and has multiple compartments, including a bottom compartment containing an impeller connected to a vertically aligned shaft, the shaft is coupled to a generator located in a top compartment of the container. An air supply pipe extends from the water surface to a middle compartment, the middle compartment contains air compressors that fill air flasks with compressed air, a valve each is configured to regulate water inflow and air pressure, an artificial intelligence (AI) module is configured to monitor and optimize the operation of the system in real-time by adjusting air pressure and impeller rotation based on ocean current predictions and external energy demand, and one or more sensors are disposed in the system to detect operational parameters and transmit real-time data to a remote control unit for predictive maintenance and automatic shutdown during hazardous conditions.

Reference will now be made in detail to the present preferred embodiments of the invention, examples of which are illustrated in the accompanying drawings. Wherever possible, the same reference numerals are used in the drawings and the description to refer to the same or like parts.

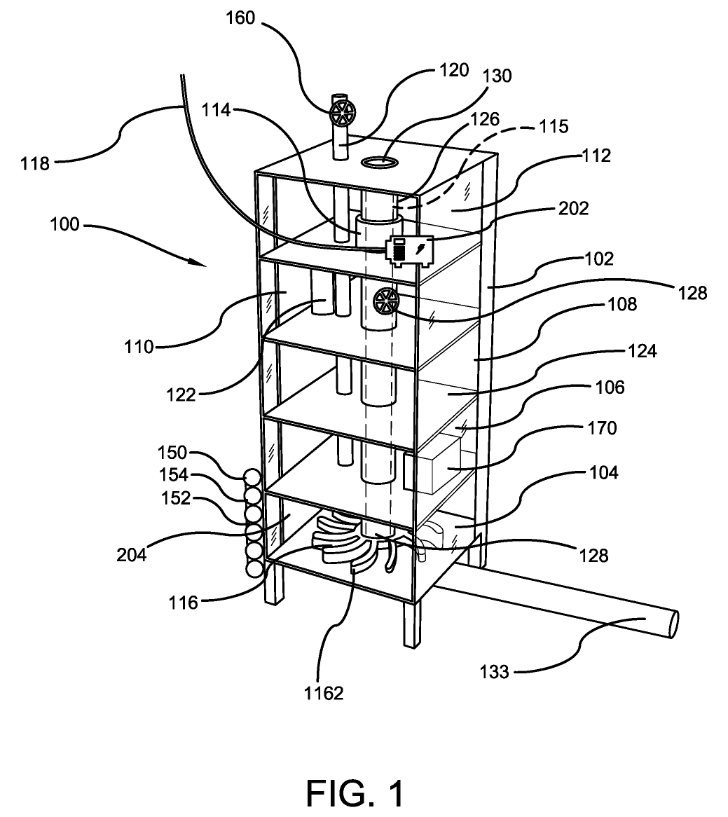

Referring initially to the drawings, FIG. 1 illustrates a perspective view of the electricity generation ocean plant 100 of the present invention in accordance with the disclosed structure. The electricity generation ocean plant system 100 of the present invention is designed as a large-scale renewable energy system to generate electricity using the kinetic energy of water in the ocean or other large bodies of water, specifically near islands or coastal areas. The system 100 uses the power of water flow and air pressure to continuously generate electricity. More specifically, the system 100 includes at least one steel tube container 102 which is preferably submerged beneath a water surface. The tube container 102 includes a plurality of watertight compartments 104,106,108,110,112 for providing functionalities for generating electricity. In one embodiment, the turbine compartment 104 may be surrounded by a second containment structure 150, positioned approximately (but not limited to) four feet away from the exterior surface of the turbine compartment 104. The structure 150 may be made from material such as but not limited to steel. The annular space 152 between the turbine compartment 104 and the structure 150 may be filled with dense material 154 such as but not limited to any combination of steel balls, concrete, or other heavy materials to induce negative buoyancy, thereby anchoring the turbine compartment 104 toward the ocean or lake bed.

At least one electric generator 114 is disposed on the top compartment 112 of the tube 102 and is adapted to generate electricity when driven by an impeller 116. The electric generator 114 is coupled to a transmission cable 118 which carries the generated electricity from the generator 114 to a shore or power grid (not shown). An air supply pipe 120 extends from the top of the tube 102 to the middle compartment 108 and allows air to be drawn in from outside of the body of water for compression and storage in the system 100. The middle compartment 110 includes one or more air compressors 122 powered by electricity (generated by the generator 114 or an external power supply), for filling one or more air flasks 124 with compressed air. The top end 302 of the air supply pipe 120 may be of sufficient length to extend above the water surface 304 to ensure continued air intake.

The impeller 116 includes a plurality of blades 1162 and is disposed in the bottom compartment 104 of the tube 102. The impeller 116 is connected to a shaft 115 that runs within a shaft 126 that runs vertically through the tube structure 102. The pipe 115 couples the impeller 116 and the generator 114, thereby allowing the impeller 116 to drive the generator 114. Initially, water flows into the impeller compartment 104 at the base of the structure 102 and the impeller compartment 104 is filled with water. A valve 128 disposed on the water supply pipe 130 closes automatically when the compartment 104 is filled and the pressurized air from the flask 124 is released into the impeller room 104 for pressurizing the water-filled impeller room 104. As the water exits the impeller compartment 104, the water flows over the impeller blades 1162 causing the impeller 116 to rotate. Rotation of the impeller 116 is transferred to the generator 114 via the connected shaft 115 for the generation of the electricity. It should be noted that the impeller 116 has fish-friendly blades to minimize the impact on marine life. The valve 128 remains closed during the air flask 124 blow-down operation to prevent backflow into the pipe 130. Water within the water supply pipe 130 drains into an opening 131 in the turbine room compartment 104. Pressurized air supplied from the compressed air flasks 124 may be released simultaneously or incrementally, as necessary, to displace the water from compartment 104 through an outlet 133 located at the base of the compartment 104. This technique is analogous to ballast tank blow operations used in submarines to achieve positive buoyancy.

The pipe 130 is used to direct water into the turbine impeller 116 to generate mechanical energy, which is then converted to electricity by the generator 114. Once the impeller 116 is activated and energy conversion occurs, the spent water is discharged through the outlet 133 at the base of compartment 104. After sufficient rotation, the valve 128 is shut, and the water is retained within compartment 104 without exiting via pipe 130. Water flow initiated through pipe 130, upon opening of valve 128, continues to drive impeller 116 and turn generator 114, supplying electricity to recharge batteries, power compressors 122, and feed the distribution line for public consumption.

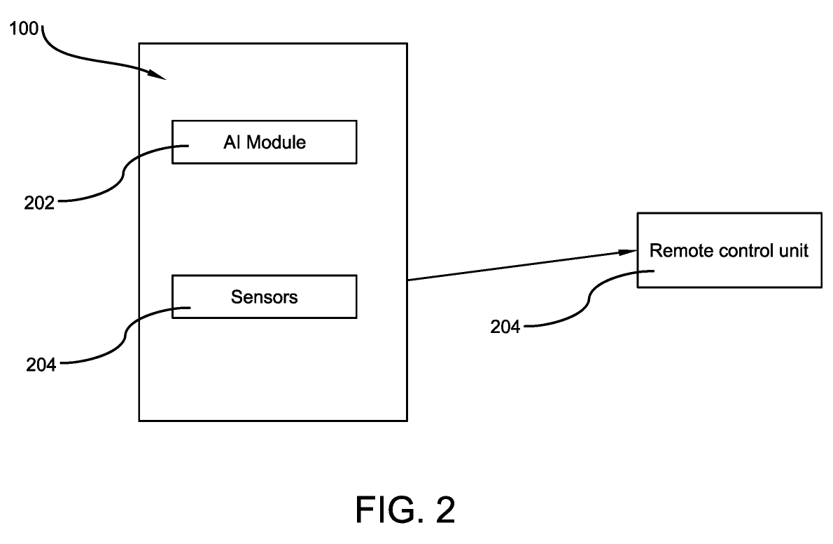

FIG. 2 illustrates a schematic view showing remote monitoring of the electricity generation ocean plant 100 of the present invention in accordance with the disclosed structure. The plant 100 includes an artificial intelligence (AI) module 202 to optimize the performance of the plant 100 in real-time and specifically, adjust the air pressure and impeller rotation speed. The AI module 202 optimizes the operation of the submerged power generation plant 100 based on ocean current predictions and the energy demand of an external shore or power grid.

One or more sensors 204 are disposed in the submerged power generation plant 100 to detect the operation of the electricity generation plant 100. The sensors 204 provide real-time information to the remote control unit 206 which can be installed on the shore or any grid wherein the unit 206 can automatically predict failures and optimize maintenance cycles in addition to automatic shutdown of the plant 100 during severe weather events.

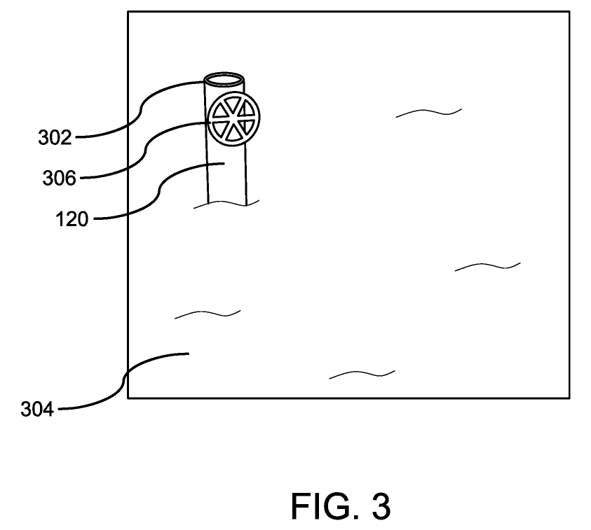

FIG. 3 illustrates a perspective view showing the electricity generation ocean plant 100 of the present invention installed in a water body in accordance with the disclosed structure. As illustrated, the top end 302 of the air supply pipe 120 is positioned over the water surface 304 of the body of water. The air from the air supply pipe 120 is drawn in for compression and storage and the air flasks 124 are filled with compressed air. The valve 306 on the air supply pipe 120 controls the air intake for the compressors 122.

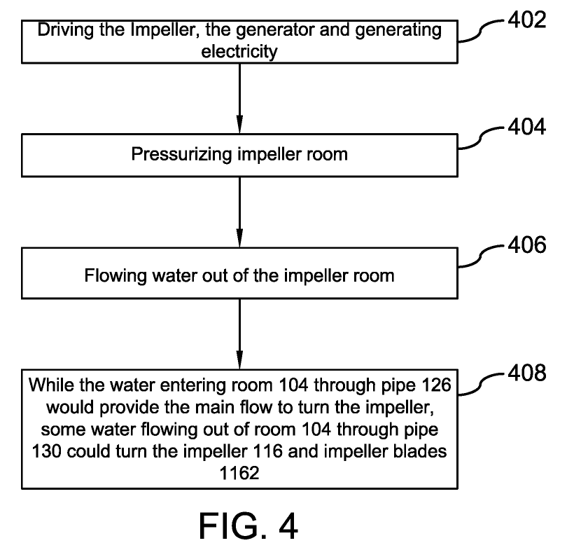

FIG. 4 illustrates a flow chart depicting a process of generation of electricity using the system 100 of the present invention in accordance with the disclosed structure. Initially, water from a body of water the system 100 is positioned in flows into the impeller room 104 at the base of the structure 102 (Step 402). The inflow of water is driven by the natural ocean current or controlled water intake and fills the impeller room 104 to almost full capacity. Then, the impeller room 104 is pressurized using air from the compressed air flasks 124 and the water is expelled through the impeller room 104 (Step 404). As water flows out of the impeller room 104, the water pushes against the impeller blades 1162 and rotates the impeller 116 (Step 406). The rotation of the impeller 116 is transferred via the connected shaft 126 to the generator 114 to produce electricity (Step 408). The mechanical rotation of the shaft 126 is converted into electrical energy by the generator 114. The energy is then transmitted through the power cable 118 that connects the generator 114 to the shore or a power grid. The air compressors 122 generate heat during operation. In some embodiments, the thermal energy could either be dissipated through heat exchangers or harnessed for additional energy conversion processes, such as combined heat and power (CHP) systems.

A sequence of operation of the system 100 may include the following. Initially, the valve 128 is shut. Next, the valve 306 in the air supply pipe 120 is opened to allow ambient air into the air compressor compartment 110. The air compressors 122 are then activated to fill the air flasks 124 with compressed air. Following this, the air intake valve 160 is shut to isolate the internal air system. The compressed air is then released from the air flasks 124 into the turbine compartment 104 to displace the water through the base outlet 133 of the compartment 104. Operation of the compressors 122 continues using power from the generator 114 and batteries 170. Once the water is completely expelled, the valve 128 is opened to allow ocean water into the pipe 130 and into compartment 104, causing the impeller 116 to rotate. This rotation turns the generator 114 for electricity generation. As the turbine room 104 is filled with water, valve 128 is shut again to stop water intake. These operational steps are repeated in sequence to maintain electricity generation.

The ocean-based renewable electricity generation system 100 is made of corrosion-resistant materials, reducing maintenance costs and increasing the lifespan of the system. A coating of self-healing polymers on the exterior of the structure 102 can be included to automatically repair minor damages caused by water pressure or marine debris. The system 100 can be designed as a modular system and can include multiple units which can be connected to create larger arrays of generators.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “ocean-based renewable electricity generation system”, “submerged power generation plant”, “electricity generation ocean plant system”, “plant”, and “system” are interchangeable and refer to the ocean-based renewable electricity generation system 100 of the present invention.

Notwithstanding the foregoing, the ocean-based renewable electricity generation system 100 of the present invention can be of any suitable size and configuration as is known in the art without affecting the overall concept of the invention, provided that it accomplishes the above stated objectives. One of ordinary skill in the art will appreciate that the ocean-based renewable electricity generation system 100 as shown in the FIGS. are for illustrative purposes only, and that many other sizes and shapes of the ocean-based renewable electricity generation system 100 are well within the scope of the present disclosure. Although the dimensions of the ocean-based renewable electricity generation system 100 are important design parameters for user convenience, the ocean-based renewable electricity generation system 100 may be of any size that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An electricity generation ocean plant system comprising:
a tube container comprised of a plurality of watertight compartments;
an impeller disposed in a turbine compartment of the plurality of watertight compartment, the impeller comprising a plurality of blades, wherein the turbine compartment is surrounded by a second containment structure;
a material positioned in an annular space between the turbine compartment and the second containment structure;
a shaft coupled to the impeller and extending vertically through the tube container;
an electric generator disposed in a top compartment of the plurality of watertight compartments, wherein the electric generator is connected to the shaft and wherein rotation of the impeller drives the electric generator to generate electricity;
a plurality of air flasks disposed within the tube container for storing a compressed air;
an air supply pipe for supplying air to the plurality of air flasks; and
a transmission cable connected to the electric generator for transmitting a generated electricity to an external location.

2. The electricity generation ocean plant system of claim 1, wherein the tube container is comprised of a corrosion-resistant material.

3. The electricity generation ocean plant system of claim 1 further comprised of a water supply pipe.

4. The electricity generation ocean plant system of claim 1, wherein the water supply pipe is comprised of a valve.

5. The electricity generation ocean plant system of claim 4, wherein the valve controls a flow of water into the bottom compartment.

6. The electricity generation ocean plant system of claim 1 further comprised of a heat exchanger.

7. The electricity generation ocean plant system of claim 1 further comprised of an air compressor.

8. The electricity generation ocean plant system of claim 7, wherein the heat exchanger dissipates thermal energy generated by the air compressor.

9. An electricity generation ocean plant system comprising:
a tube container having a plurality of watertight compartments;
an impeller housed in a turbine compartment of the tube container, the impeller being configured to rotate in response to water flow, wherein the turbine compartment is surrounded by a second containment structure;
a material positioned in an annular space between the turbine compartment and the second containment structure;
an electric generator positioned in a top compartment of the tube container, the electric generator coupled to the impeller by a vertical shaft;
an air compressor disposed within a middle compartment of the tube container and configured to receive an air from an air supply pipe;
a plurality of air flasks for storing a compressed air produced by the air compressor; and
a control system configured to regulate an air pressure within the bottom compartment to control a rotation speed of the impeller.

10. The electricity generation ocean plant system of claim 9 further comprised of a valve.

11. The electricity generation ocean plant system of claim 10, wherein the valve controls an air intake into an air supply tube.

12. The electricity generation ocean plant system of claim 9, wherein the air compressor is powered by the electric generator.

13. The electricity generation ocean plant system of claim 9 further comprised of a sensor.

14. The electricity generation ocean plant system of claim 13, wherein the sensor detects an operational status of the electric generator.

15. The electricity generation ocean plant system of claim 13, wherein the sensor transmits data to a remote control unit.

16. The electricity generation ocean plant system of claim 9, wherein the control system is configured to automatically close a valve of a water supply pipe when the water-filled bottom compartment is filled with water.

17. The electricity generation ocean plant system of claim 9, wherein the tube container is comprised of a steel.

18. The electricity generation ocean plant system of claim 9 further comprised of an AI module.

19. The electricity generation ocean plant system of claim 18, wherein the AI module optimizes a performance of the electricity generation ocean plant system.

20. A method of using an electricity generation ocean plant system, the method comprising the following steps:
positioning a tube container in a body of water, the tube container comprised of a plurality of watertight compartments including a turbine compartment surrounded by a second containment structure and wherein a material is positioned in an annular space between the turbine compartment and the second containment structure, a middle compartment, and a top compartment;
allowing a water from the body of water to flow into the bottom compartment;
pressurizing the bottom compartment by releasing a compressed air stored in an air flask located in the middle compartment;
expelling the water from the bottom compartment while rotating an impeller disposed in the bottom compartment, the rotation caused by the flow of water over a plurality of blades of the impeller;
transferring the rotational movement of the impeller via a connected shaft to an electric generator located in the top compartment;
generating electricity with the electric generator from the rotational movement of the shaft; and
transmitting the generated electricity from the electric generator.
